(19) United States
(12) Patent Application Publication
(10) Pub. No.: US 2023/0041408 A1
(43) Pub. Date: Feb. 9, 2023

(54) METHOD FOR PRODUCING FULLERENE-DERIVATIVE-CONTAINING RESIN COMPOSITION, FULLERENE-DERIVATIVE-CONTAINING RESIN COMPOSITION OBTAINED FROM SAME, RESIN PAINT, RESIN COATING, AND ENAMEL WIRE

(71) Applicant: TOTAI CO., LTD., Tokyo (JP)

(72) Inventors: Akio HARADA, Kyoto (JP); Yasuharu MIYASHITA, Osaka (JP); Takeshi NOGUCHI, Oita (JP); Juichi KASAI, Tokyo (JP)

(73) Assignee: TOTAI CO., LTD., Tokyo (JP)

(21) Appl. No.: 17/912,400

(22) PCT Filed: Mar. 18, 2021
(86) PCT No.: PCT/JP2021/011006

§ 371 Date: Sep. 16, 2022

(30) Foreign Application Priority Data
Mar. 30, 2020 (JP) 2020-060339

(51) Int. Cl. C08K 3/04; C08J 3/20; C09D 179/08; C08K 9/04; H01B 3/30

(52) U.S. Cl. CPC C08K 3/045; C08J 3/203; C09D 179/08; C08K 9/04; H01B 3/306; C08J 2479/08

(57) ABSTRACT

Provided is a method for producing a material that suppresses a decrease in the life of an insulation against surge voltage, that is, a material that provides a long dielectric breakdown lifetime. The method is a method for producing a fullerene-derivative-containing resin composition containing a fullerene derivative and a resin that has an affinity for a polar solvent, including: a step (I) of dispersing a fullerene derivative in a polar solvent; and a step (II) of mixing the polar solvent in which the fullerene derivative is dispersed with a resin that has an affinity for the polar solvent.

### TECHNICAL FIELD

The present disclosure relates to a method for producing a fullerene-derivative-containing resin composition, a fullerene-derivative-containing resin composition obtained from the same, a resin paint, a resin coating, and an enamel wire, in order to provide a material that suppresses a decrease in the life of an insulation against surge voltage, that is, a material that provides a long dielectric breakdown lifetime.

### BACKGROUND ART

In recent years, electric vehicles using motors as the drive source have been developed. Motor manufacturers have released prototype in-wheel motors with inverters. Electric motors are an attractive power source that can generate high torque from low to high RPM, but, at present, motors used in electric vehicles can generate high torque only at low RPM and the torque at high RPM depends on conventional technologies such as transmissions and engines (hybrid vehicles). Therefore, for the development of full-scale electric vehicles, it is considered essential to put into practical use motors that can generate high torque from low RPM to high RPM.

High-RPM and high-torque motors have an issue in that the life of motor wires decreases due to surge voltage generated by inverter control units. It is considered that surge voltage is about twice the input voltage, and its frequency of occurrence is proportional to the frequency.

In order to realize high torque and high RPM, the frequency has to be increased to about 10 times the current level. In other words, the life of insulations of motor wires against surge voltage has to be prolonged by a factor of 10 or more.

Assuming that the warranty period for current automotive motors is 10 years, the warranty period under conditions that the frequency is increased by a factor of 10 would be 1 year, which is not realistic. In order to increase the frequency to about 10 times the current level, it is necessary to prolong the life of insulations of motor wires against surge voltage by a factor of 10 or more.

Degradation of motors due to surge voltage is considered to be caused by corona discharges that occur between motor wires. The partial discharge inception voltage V, which is the voltage at which discharge begins between wires, is expressed by Dakin's formula below.

V=α(t/ε)^{0.46}

α: Constant (α=720 when t is in mils)

ε: Dielectric constant of insulating layer

t: Thickness of insulating layer

Heat resistance is another important property required for insulations for high-RPM and high-torque motors. In other words, heat-resistant materials are selected due to requirements for cooling motors in high-RPM and high-torque conditions.

Fullerenes are spherical carbon compounds with a diameter of approximately 1 nm, and are expected to have the ability to alleviate charge accumulation inside insulations because they are heat-resistant materials and have an excellent electron acceptability. However, although attempts were made to utilize fullerenes, it has been difficult to achieve uniform nano-dispersion of fullerenes and fullerene derivatives in synthetic resins due to their strong cohesive properties and poor miscibility with synthetic resins.

NPL 1 describes measurement of a voltage at which electrical treeing is generated at AC using, as power cable insulations, cross-linked polyethylene insulations in which C₆₀ fullerene and C₆₀—PCBM are each nano-dispersed. The measurement results showed that cross-linked polyethylene insulations in which C₆₀ fullerene and C₆₀—PCBM were nano-dispersed each in an amount of 1 mmol/kg (about 0.1% by weight) had improved voltage resistance at AC compared with cross-linked polyethylene insulations without the above-mentioned materials, the voltage resistance being improved by 15% in the case of C₆₀ fullerenes and 26% in the case of C₆₀-PCBM.

In addition, PTL 1 discloses an electrical insulating varnish produced by adding and dispersing a silica sol in an amount of 5 to 100 parts by weight (silica equivalent) with respect to 100 parts by weight of insulation resin, the silica sol being dispersed in a mixed solvent of resin solvent, alcohol, naphtha, and the like, and describes that inverter surge resistant coils produced by impregnating coils of electrical equipment with the above-mentioned varnish and solidifying the varnish had a dielectric breakdown lifetime that was six or more times as long as that of coils without the varnish.

### RELATED ART DOCUMENTS

### Non-Patent Documents

NPL 1: Markus Jarvid, Anette Johansson, Renee Kroon, Jonas M. Bjuggren, Harald Wutzel, Villgot Englund, Stanislaw Gubanski, Mats R. Andersson, and Christian Muller, “A New Application Area for Fullerenes: Voltage Stabilizers for Power Cable Insulation”, Advanced Materials 2015, 27, 897-902
NPL 2: E. Markus Jarvid, Anette B. Johansson, Jorgen H. M. Blennow, Mats R. Andersson and Stanislaw M. Gubanski, “Evaluation of the Performance of Several Object Types for Electrical Treeing Experiments”, IEEE Transactions on Dielectrics and Electrical Insulation, Vol. 20, No. 5, October 2013, 1712-1719

### Patent Document

PTL 1: Japanese Patent No. 4061981

### SUMMARY

Although NPL 1 above does not describe a method for uniformly nano-dispersing fullerenes in polyethylene, NPL 2 above describes, as a method for producing cable insulations, a method of obtaining a nano-dispersion, including cooling and solidifying a mixture of polyethylene, an antioxidant (fullerene), and a cross-linking agent, with use of nitrogen, pulverizing the solidified product, and melting the uniformly-mixed fine powder. However, such a method cannot be used at the industrial level for reasons of complexity and economy.

In PTL 1 above, the amount of silica sol added with respect to 100 parts by weight of insulation resin is 5 to 100 parts by weight (silica equivalent), and this large amount of silica sol increases the rigidity of coils, which leads to issues such as difficulty in winding coils closely together and an increase in the weight of the motor.

In such circumstances, the present disclosure provides a method for producing a fullerene-derivative-containing resin composition, a fullerene-derivative-containing resin composition obtained from the same, a resin paint, a resin coating, and an enamel wire, in order to provide a material that, when contained even in a small amount, suppresses a decrease in the life of an insulation against surge voltage and suppresses a decrease in the life, that is, a material that, when contained even in a small amount, provides a long dielectric breakdown lifetime.

In order to achieve the above-mentioned object, the present inventors conducted an in-depth study in order to address the above-mentioned issues, and found that, if a fullerene derivative is dispersed in a polar solvent and then the polar solvent in which the fullerene derivative is dispersed is mixed with a resin that has an affinity for the polar solvent, the resulting fullerene-derivative-containing resin composition contains the fullerene derivative in a highly-dispersed state.

That is to say, the present disclosure provides [1] to [10] below.

[1] A method for producing a fullerene-derivative-containing resin composition containing a fullerene derivative and a resin that has an affinity for a polar solvent, including:

a step (I) of dispersing a fullerene derivative in a polar solvent; and

a step (II) of mixing the polar solvent in which the fullerene derivative is dispersed with a resin that has an affinity for the polar solvent.

[2] The method for producing a fullerene-derivative-containing resin composition according to [1], in which the fullerene derivative is a fullerene expressed by General Formula (1) below:

Cₙ[O(CH₂)ₓCH₃]_{y}(OH)_{z} (1)

(where n is an integer of 60 or more, x is an integer of 3 or more, y is an integer of 1 or more, and z is an integer of 0 or more).

[3] The method for producing a fullerene-derivative-containing resin composition according to [1] or [2], in which the polar solvent is a solvent having an amide bond.
[4] The method for producing a fullerene-derivative-containing resin composition according to any one of [1] to [3], in which the polar solvent is N-methyl-2-pyrrolidone.
[5] A fullerene-derivative-containing resin composition obtained using the method for producing a fullerene-derivative-containing resin composition according to any one of [1] to [4].
[6] A fullerene-derivative-containing resin composition including: a fullerene derivative; and a resin that has an affinity for a polar solvent, in which the resin composition has a dielectric breakdown lifetime that is 10 or more times as long as that of a resin without the fullerene derivative, as measured according to measurement conditions below:

Measurement Conditions

the resin composition shaped to have a size of 50×50×0.2 to 0.4 mm is used as a test piece and measured in an AC voltage range of 10 to 100 kV and at a voltage rise rate of 1 kV/sec and a frequency of 60 Hz.

[7] The fullerene-derivative-containing resin composition according to [5] or [6], in which the fullerene derivative is contained in an amount of 0.0001 to 5% by weight of the resin composition.
[8] A resin paint including, as a main component, the fullerene-derivative-containing resin composition according to any one of [5] to [7].
[9] A resin coating obtained by solidifying the resin paint according to [8].
[10] An enamel wire including: a conductor; and the resin coating according to [9] arranged on an outer circumferential face of the conductor.

In this manner, the present disclosure is directed to a method for producing a fullerene-derivative-containing resin composition containing a fullerene derivative and a resin that has an affinity for a polar solvent, including: a step (I) of dispersing a fullerene derivative in a polar solvent; and a step (II) of mixing the polar solvent in which the fullerene derivative is dispersed with a resin that has an affinity for the polar solvent. Thus, according to this production method, the resulting fullerene-derivative-containing resin composition contains the fullerene derivative in a highly-dispersed state and can suppress a decrease in the life of an insulation against surge voltage.

Furthermore, in particular, if the fullerene derivative is a fullerene expressed by General Formula (1) below, the dispersibility of the fullerene derivative in the resin composition is further improved.

Cₙ[O(CH₂)ₓCH₃]_{y}(OH)_{z} (1)

(where n is an integer of 60 or more, x is an integer of 3 or more, y is an integer of 1 or more, and z is an integer of 0 or more)

Furthermore, in particular, if the polar solvent is a solvent having an amide bond, it can link the resin and the fullerene derivative, and thus the dispersibility of the fullerene derivative in the resin composition is further improved.

Furthermore, in particular, if the polar solvent is N-methyl-2-pyrrolidone, the dispersibility of the fullerene derivative in the resin composition is further improved.

Furthermore, the fullerene-derivative-containing resin composition obtained by the production method of the present disclosure has a long dielectric breakdown lifetime, and thus a resin paint, a resin coating, and an enamel wire using the resin composition also have a long dielectric breakdown lifetime.

### DESCRIPTION OF EMBODIMENTS

The present disclosure is directed to a method for producing a fullerene-derivative-containing resin composition (which may be hereinafter abbreviated as “resin composition”) containing a fullerene derivative and a resin that has an affinity for a polar solvent. According to this production method, the dispersibility of the fullerene derivative in the resin composition is very high.

First, the fullerene-derivative-containing resin composition obtained by this production method will be described.

### Fullerene Derivative

The above-mentioned fullerene-derivative-containing resin composition contains a fullerene derivative and a resin that has an affinity for a polar solvent. Hereinafter, the fullerene derivative will be described.

The fullerene derivative is obtained by chemically modifying part of the fullerene skeleton of C₆₀ and C₇₀, which are fullerenes with 60 and 70 carbon atoms respectively, and collectively refers to various types of compounds such as, for example, C₆₀(OH)n, chlorinated fullerene, phenolic fullerene (phenol-C₆₀), (6,6)-phenyl C₆₁ butyric acid methyl ester (C₆₁—PCBM), long-chain alkylated fullerene, long-chain alkyl-etherified fullerene, and the like. These compounds can be used alone or in a combination of two or more.

The above-mentioned fullerene skeleton is a collective term for skeletons constituted by carbon molecules in the shape of hollow spheres. Examples of carbon molecules that can form molecules in the shape of hollow spheres include nanomaterials expressed by the general formula Cₙ (n is an integer of 60 or more).

The term “nanomaterials” means substances with at least one dimension that is smaller than 100 nm.

Furthermore, as the above-mentioned fullerene derivative, a long-chain alkyl-etherified fullerene is preferably used. Since a long-chain alkyl-etherified fullerene has an excellent affinity for a dispersion medium resin, when mixed with the above-mentioned resin, molecules of the long-chain alkyl-etherified fullerene do not aggregate, and a resin in which the long-chain alkyl-etherified fullerene is stably nano-dispersed can be easily obtained. Accordingly, this material can be applied to electric wires such as enamel wires that are required to be uniform in the length direction.

As long as the above-mentioned long-chain alkyl-etherified fullerene contains a long-chain alkyl group with 4 or more carbon atoms, the alkyl group may be either linear or branched. Furthermore, although the number of carbon atoms contained in the alkyl group is 4 or more, it is preferably 6 or more from the viewpoint of improving the miscibility with resins, and the upper limit thereof is typically 12.

Moreover, it is preferable that the above-mentioned fullerene derivative is a fullerene expressed by General Formula (1) below:

Cₙ[O(CH₂)ₓCH₃]_{y}(OH)_{z} (1)

(where n is an integer of 60 or more, x is an integer of 3 or more, y is an integer of 1 or more, and z is an integer of 0 or more).

In General Formula (1) above, y+z is preferably 3 to 14, and more preferably 5 to 12, in order to perform synthesis under convenient conditions. For example, if the total number of substituents y+z=10, y is 1 or more, but it is preferably 5 to 9 from the viewpoint of dispersibility and amphiphilicity. Furthermore, z is an integer of 0 or more, but it is preferably 1 to 5 from the viewpoint of heat resistance and stability. Therefore, the ratio between y and z (the number of long-chain alkyl groups/the number of hydroxyl groups) is preferably 1/1 to 9/1 from the viewpoint of obtaining miscibility with resins and contributing to an improvement of heat resistance without impairing other advantages.

The content of the fullerene derivative is preferably 0.0001 to 5% by weight, more preferably 0.001 to 1% by weight, and even more preferably 0.001 to 0.5% by weight, of the resin composition excluding the solvent. Furthermore, the content is preferably 0.0001 to 0.3% by weight, more preferably 0.0005 to 0.2% by weight, and even more preferably 0.001 to 0.1% by weight, from the viewpoint of increasing the partial discharge inception voltage (preventing charge from accumulating in the insulation).

### Method for Producing Fullerene Derivative

The method for producing the above-mentioned fullerene derivative is, for example, a method including: a first step of synthesizing polycyclosulfated fullerene (CS) from untreated fullerene and fuming sulfuric acid; and a second step of introducing at least one or more alkyl groups to the fullerene skeleton by means of an ether bond generated by reacting the CS with a long-chain alcohol, thereby synthesizing an alkyl-etherified fullerene derivative.

Furthermore, instead of the CS, it is also possible to use other fullerene derivatives having a substituent that is likely to be desorbed through a nucleophilic substitution reaction of an alcohol, such as a halogenated fullerene having any one of a fluorine atom, a chlorine atom, and a bromine atom as a substituent on the fullerene skeleton, or a nitrated fullerene having a nitro group, but the method in which the CS is reacted with a long-chain alcohol is preferable.

The method may further include other steps such as pretreatment and aftertreatment for the purpose of purification, before or after the first and second steps.

### Resin Having Affinity for Polar Solvent

First, a polar solvent will be described prior to a description of a resin that has an affinity for the polar solvent.

### Polar Solvent

The polar solvent may be any liquid constituted by molecules with a large dipole moment, among which a liquid whose SP value (solubility parameter) is 10 to 13 is preferable. In the present disclosure, the polar solvent functions as a solvent that swells and dissolves a resin that has an affinity for the polar solvent.

Examples of the polar solvent include: non-protic polar solvents such as N-methyl-2-pyrrolidone, N-formylmorpholine, N-acetylmorpholine, N,N′-dimethylethyleneurea, N,N-dimethylacetamide, and N,N-dimethylformamide; and protic polar solvents such as hexafluoroisopropanol, formic acid, and various alcohols (e.g., lower alcohols with 1 to 6 carbon atoms such as methanol, ethanol, 2-propanol, etc.). These polar solvents can be used alone or in a combination of two or more.

In particular, from the viewpoint of solubility, the polar solvent is preferably a polar solvent having an amide bond, more preferably a non-protic polar solvent such as N-methyl-2-pyrrolidone, N-formylmorpholine, N-acetylmorpholine, N,N′-dimethylethyleneurea, N,N-dimethylacetamide, or N,N-dimethylformamide, and even more preferably N-methyl-2-pyrrolidone.

The content of the polar solvent having an amide bond is preferably 10 to 100% by weight when the total content of the polar solvent is taken as 100% by weight.

The properties of the fullerene derivatives used tend to determine the solvents in which nano-dispersion is possible. For example, although phenol-C₆₀ having a polarity is dissolved in 1,4-dioxane, which is a polar solvent, it is sufficiently dispersed but has a rather large molecular size in tetrahydrofuran (THF), and is not dissolved in toluene having a lower polarity.

The content of the polar solvent to be blended with 1 g of the fullerene derivative is preferably 10 to 500 mL, more preferably 30 to 300 mL, and even more preferably 50 to 200 mL.

### Resin Having Affinity for Polar Solvent Dispersion Medium Resin

The resin that has an affinity for the polar solvent may be any resin that has an affinity for the polar solvent, among which a polar resin is preferable. In the present disclosure, fullerene derivatives are dispersed in this resin, and thus it is sometimes referred to as a “dispersion medium resin”.

Examples of the dispersion medium resin include polyamide-imide resin, epoxy resin, mixtures of polyamide-imide resin and epoxy resin, polyester resin, vinylester resin, and phenolic resin. These resins can be used alone or in a combination of two or more. In particular, from the viewpoint of affinity and heat resistance, the dispersion medium resin is preferably polyamide-imide resin and epoxy resin, and more preferably polyamide-imide resin.

In particular, from the viewpoint of heat resistance, the dispersion medium resin preferably contains polyamide-imide resin as a main component. Furthermore, if the polar solvent has an amide bond, the affinity for this resin is enhanced, which is preferable.

In the present disclosure, the term “main component” means a component that significantly affects the properties of the dispersion medium resin, and, typically, the content of that component is preferably 50% by weight or more, more preferably 60% by weight or more, and even more preferably 70% by weight or more, of the total content of the dispersion medium resin.

If the dispersion medium resin contains polyamide-imide resin as a main component, the other resins are preferably epoxy resin, which is versatile.

The epoxy resin may be of the bisphenol, novolac, aliphatic, or amine type according to the type of basic base, and solvents that have an affinity therefor vary widely depending on the combination of each with the basic base and a curing agent, but a bisphenol epoxy resin is preferable from the viewpoint of its high affinity for the polar solvent.

The content of the fullerene derivative in the dispersion medium resin is preferably 0.0001 to 5% by weight, more preferably 0.001 to 1% by weight, and even more preferably 0.001 to 0.5% by weight. Furthermore, the content is preferably 0.0001 to 0.3% by weight, more preferably 0.0005 to 0.2% by weight, and even more preferably 0.001 to 0.1% by weight, from the viewpoint of increasing the partial discharge inception voltage (preventing charge from accumulating in the insulation).

Furthermore, the above-mentioned dispersion medium resin preferably has an affinity not only for the polar solvent but also for the fullerene derivative. If the affinity is low, the particle size of the fullerene derivative tends to increase rapidly due to stirring or impact during storage or application, concentration during heat treatment, or the like, and thus, enamel wires and the like cannot be uniform in the length direction, and even enamel wires that showed good results in sampling tests may not achieve the initial effects after being assembled into motors.

### Resin Composition and Method for Producing the Same

The fullerene-derivative-containing resin composition of the present disclosure contains the above-mentioned fullerene derivative and the above-mentioned resin (dispersion medium resin) that has an affinity for the polar solvent, and is obtained through the steps (I) and (II) below. The obtained resin composition is excellent in terms of dispersibility of the fullerene derivative in the resin composition.

Step (I) of dispersing a fullerene derivative in a polar solvent

Step (II) of mixing the polar solvent in which the fullerene derivative is dispersed with a resin that has an affinity for the polar solvent

In the step (I), the polar solvent has a high dissolving ability, and thus, when the fullerene derivative is dispersed in the polar solvent, excellent dispersibility is exhibited. Examples of the dispersion method include agitation and mixing with a vane agitator, ultrasonic treatment, a homogenizer, a ball mill, and the like. In particular, from the viewpoint of dispersibility, the method preferably uses ultrasonic treatment.

Furthermore, in the step (II), when the polar solvent in which the fullerene derivative is dispersed in the step (I) is mixed with the dispersion medium resin, the polar solvent penetrates the boundary of the dispersion medium resin and the dispersion medium resin swells rapidly. Then, through stirring, nanoparticles of the fullerene derivative with high electron-trapping ability are placed in the free volume at the boundary of the dispersion medium resin in the swollen state. Accordingly, it is possible to obtain a dispersion medium resin in which a fullerene derivative with electron-trapping ability is uniformly nano-dispersed.

There is no particular limitation on the mixing method in the step (II), but examples thereof include a method in which the polar solvent in which the fullerene derivative is dispersed is added to the dispersion medium resin, and the mixture is stirred and mixed by a vane agitator, ultrasonic treatment, a homogenizer, a ball mill, and the like, after which the solvent is removed by heat or the like, and a method in which the polar solvent in which the fullerene derivative is dispersed is mixed with the dispersion medium resin, and the mixture is melted and mixed with stirring, after which the solvent is removed by heat or the like. Examples of the melt-kneading include a method in which a mixture of the fullerene derivative and the resin is melted and kneaded in a kneader, a Bunbury mixer, a roll, or the like. In particular, from the viewpoint of dispersibility, the method preferably uses ultrasonic treatment, and more preferably uses ultrasonic treatment at a mixing temperature of 10 to 40° C. for 0.5 to 1 hour.

It seems that the obtained dispersion medium resin in which the fullerene derivative is uniformly nano-dispersed traps electrons and prevents space charges from accumulating in the insulating layer. As a result, the AC treeing generating voltage, which controls insulation performance and charge degradation, can be significantly increased.

Furthermore, the resin composition of the present disclosure has a dielectric breakdown lifetime that is preferably 10 or more times, more preferably 15 or more times, even more preferably 18 or more times, and further preferably 20 or more times as long as that of a resin without the fullerene derivative, as measured according to measurement conditions below. The upper limit thereof is typically 10000 hours. At the time of measurement, if a solvent is present in the resin composition, it has to be removed before measurement. Furthermore, the term “resin without the fullerene derivative” means a resin obtained by removing the fullerene derivative from the fullerene-derivative-containing resin composition of the present disclosure that is to be measured (the system to which the fullerene derivative is not added).

### Measurement Conditions

The resin composition shaped to have a size of 50×50×0.2 to 0.4 mm is used as a test piece and measured in an AC voltage range of 10 to 100 kV and at a voltage rise rate of 1 kV/sec and a frequency of 60 Hz.

The resin composition of the present disclosure can realize a long dielectric breakdown lifetime. Therefore, it can be inferred that the resin composition is in a “nano-dispersion” state in which the fullerene derivative in the form of a nanomaterial is dispersed. The nano-dispersion also encompasses a case in which the nanomaterial is at the molecular level.

The resin composition according to the present disclosure may contain, in addition to the fullerene derivative and the dispersion medium resin described above, optional components such as polar solvents, solvents other than polar solvents, plasticizers, dispersants, antioxidants, heat stabilizers, UV absorbers, weather stabilizers, anti-dripping agents, mold release agents, lubricants, flame retardants, colorants, antimicrobial agents, antistatic agents, and other additives, glass fiber, carbon fiber, high melting point organic fiber, carbon black, silica, calcium carbonate, clay, talc, shirasu-balloon, and glass balloon.

Since the polar solvents will eventually be removed during formation of products, there is no particular limitation on the content of the polar solvents.

As long as the effects of the present disclosure are not inhibited, there is no limitation on the contents of the above-mentioned optional components.

### Resin Paint

The resin paint of the present disclosure contains, as a main component, the fullerene-derivative-containing resin composition obtained as described above, that is, the dispersion medium resin in which the fullerene derivative is nano-dispersed. If the dispersion medium resin in which the fullerene derivative is nano-dispersed is contained as a main component in this manner, it is possible to obtain a resin paint in which the fullerene derivative is nano-dispersed.

The term “main component” means a component that significantly affects the properties of the material, and, typically, the content of that component is preferably 50% by weight or more, more preferably 60% by weight or more, even more preferably 70% by weight or more, and most preferably 100% by weight, of the total content of the material.

The content of the fullerene derivative in the resin paint (excluding the solvent) is preferably 0.0001 to 5% by weight, more preferably 0.001 to 1% by weight, and even more preferably 0.001 to 0.5% by weight. If the content is within the above-mentioned range, the resin coating obtained by solidifying the resin paint is excellent in terms of life against surge voltage. In particular, if the content is 0.001% by weight or more, the life of the resin coating against surge voltage can be 20 or more times as long as that of a resin coating without the fullerene derivative. Furthermore, from the viewpoint of increasing the partial discharge inception voltage (preventing charge from accumulating in the insulation), the content is preferably 0.0001 to 0.3% by weight, more preferably 0.0005 to 0.2% by weight, and even more preferably 0.001 to 0.1% by weight.

If the viscosity and other properties of the dispersion medium resin in which the fullerene derivative is nano-dispersed are adjusted according to the applications, it is possible to obtain a resin paint in which the fullerene derivative is nano-dispersed.

### Resin Coating

In the present disclosure, the resin coating formed by solidifying the resin paint in which the fullerene derivative is nano-dispersed has partial discharge resistance and heat resistance.

There is no particular limitation on the solidifying method, but examples thereof include desolvating, defoaming, light curing, and heat curing, among which a combination of desolvating and defoaming by heating is preferable.

A more preferable method for forming a resin coating is, for example, a method in which the above-mentioned resin paint is poured into a molding die or the like, and heated (at 80 to 200° C. for 24 to 48 hours) using a low-pressure dryer (0.1 Pa or less) to be defoamed and desolvated. The obtained resin coating has heat resistance and partial discharge resistance.

It seems that, since the electron acceptability of the fullerene derivative is proportional to the surface area of the fullerene skeleton, nanoparticles of the fullerene derivative in the resin coating are present in the resin coating without aggregating, which improves the electron acceptability per mole. Therefore, even when the above-described resin paint is kneaded during enamel wire production, the nanoparticles of the fullerene derivative nano-dispersed in the paint do not aggregate and can exist stably in the length direction of enamel wires.

### Enamel Wire

The enamel wire of the present disclosure is excellent in terms of heat resistance and partial discharge resistance because the resin coating having heat resistance and partial discharge resistance is arranged on the outer circumferential face of the conductor.

In the case of an enamel wire, a conductor is continuously immersed in the resin paint in which the fullerene derivative is nano-dispersed, and the excess resin paint is removed, so that the thickness of the resin paint is made constant, after which the conductor is heated and desolvated in a tunnel-type heater to continuously produce an enamel wire having heat resistance and partial discharge resistance.

The resin coating obtained by solidifying the resin paint has a life against surge voltage that is 20 or more times as long as that of conventional coatings. Accordingly, if an enamel wire in which the resin coating of the present disclosure is arranged on the outer circumferential face of the conductor is used, it is possible to realize an electric vehicle using a high-torque and high-RPM motor without decreasing the life of the motor due to surge voltage generated by the inverter control unit.

### EXAMPLES

Hereinafter, the present disclosure will be described in detail by way of examples. Note that the scope of the present disclosure is not limited to these examples as long as it does not depart from the gist thereof.

### Example 1

### Synthesis of Fullerene Derivative

A fullerene derivative for use in the resin composition was synthesized by the following method.

### Preparation of Long-Chain Alkyl-Etherified Fullerene Derivative

A fullerene (C₆₀) (product name: nanom purple ST) serving as a raw material was purchased from Frontier Carbon Corporation.

The first step of synthesizing polycyclosulfated fullerene (CS) was performed as follows according to Reference Example 1 in Examples of JP-A-2005-251505.

First, 5 g of fullerene (CO was reacted with 75 mL of 60 wt. % fuming sulfuric acid in a nitrogen atmosphere at 60° C. for 3 days with stirring. Next, the resulting reaction product was added dropwise into 500 mL of diethyl ether in an ice bath to obtain a precipitate. The resulting precipitate was separated by centrifugation, and the separation was washed by adding about 1000 mL in total of anhydrous diethyl ether in several portions, further washed with about 300 mL of diethyl ether/acetonitrile=2/1 mixed solvent, and vacuum dried to obtain a sample (CS).

The infrared absorption spectrum (IR spectrum) of the obtained sample (CS) was in good agreement with the infrared absorption spectrum (IR) in FIG. 1 of JP-A-2005-251505, which means that the obtained material is polycyclosulfated fullerene (CS).

Next, the second step of synthesizing hexyl-etherified fullerene hydroxide (HexC₆₀) was performed as follows.

First, 2 g of the obtained polycyclosulfated fullerene (CS) was reacted with 20 mL of hexanol in a nitrogen atmosphere at 80° C. for 2 days with stirring. The reaction product was mixed with about 910 mL of methanol and centrifuged to collect the precipitate product and remove unreacted hexanol, and then sulfuric acid was washed off with water until the pH reached 6.5 to obtain 0.95 g of hexyl-etherified fullerene hydroxide (HexC₆₀).

Hexyl-etherified fullerene hydroxide (HexCO₆₀) was identified from the infrared absorption spectrum (IR spectrum) measurement, and its structural formula was determined as being C₆₀[O(CH₂)₅CH₃]₄(OH)₅ through the elemental analysis measurement, which means that the obtained material is hexyl-etherified fullerene hydroxide (HexC₆₀).

### Production of Resin Composition and Resin Composition Film

First, 1.57 mg of hexyl-etherified fullerene hydroxide derivative (HexC₆₀) was added to 1000 g of N-methyl-2-pyrrolidone (SP value: 11.2) and subjected to ultrasonic treatment to prepare a 0.000157 wt. % solution. Then, 30.79 g of this solution was added to 30.79 g of polyamide-imide resin (Pyromax HR-11 (concentration: 15% by weight) manufactured by Toyobo Co., Ltd.), and the resulting resin solution was dissolved through ultrasonic treatment.

This resin solution was poured into a 120×120×10-mm hollowed-out TEFLON (registered trademark) plate, and defoamed and desolvated at 140° C. using a low-pressure dryer to produce a film with a thickness of 0.328 mm containing a hexyl-etherified fullerene hydroxide derivative (HexC₆₀) in an amount of 0.0083 mmol/kg (0.001% by weight) with respect to the polyamide-imide resin.

### Dielectric Breakdown Lifetime of Film

A film sample cut to have a size of 50 mm×50 mm was subjected to the breakdown voltage measurement (also referred to as “withstand voltage measurement”) using an AC high voltage generator (“100 kV 20 kVA” manufactured by Tokyo Henatsuki K. K.) under the conditions of electrode: in electrically insulating oil, voltage rise rate: 1 kV/sec, current: AC, and frequency: 60 Hz.

The dielectric breakdown lifetime was obtained from the breakdown voltage measurement following the procedure below.

(1) Measure the breakdown voltage of the sample
(2) Measure the time to breakdown at an applied voltage that is not greater than the breakdown voltage (at multiple points)
(3) Find an equation relating the applied voltage and the breakdown time
(4) Determine the breakdown time using 30 kV/mm as the threshold and use it as the lifetime

### Partial Discharge Inception Voltage of Film

The partial discharge inception voltage was measured using a discharge detector “B010” (manufactured by Fujikura Dia Cable Ltd., upper electrode: 20 mmΦ sphere, and lower electrode: 25 mmΦ cylinder).

The measurement conditions were as follows: voltage rise rate 2 kV/12 sec (10 kV/min)→hold for 5 sec (2 kV)→voltage drop rate 2 kV/12 sec (10 kV/min), and frequency: 60 Hz.

The voltage (threshold) at a charge of 100 pC was taken as the partial discharge inception voltage.

These measurement results showed that the dielectric breakdown lifetime was 20 hours and the partial discharge inception voltage was 3.89 kV/mm. Table 1 below shows the measurement results.

### Example 2

A film with a thickness of 0.293 mm containing a hexyl-etherified fullerene hydroxide derivative (HexC₆O in an amount of 0.083 mmol/kg (0.01% by weight) with respect to the polyamide-imide resin was produced in a way similar to that of Example 1.

Measurement results of the dielectric breakdown lifetime and the partial discharge inception voltage showed that the dielectric breakdown lifetime was 33 hours and the partial discharge inception voltage was 3.65 kV/mm. Table 1 below shows the measurement results.

### Example 3

A film with a thickness of 0.319 mm containing a hexyl-etherified fullerene hydroxide derivative (HexC₆₀) in an amount of 0.827 mmol/kg (0.1% by weight) with respect to the polyamide-imide resin was produced in a way similar to that of Example 1.

Measurement results of the dielectric breakdown lifetime and the partial discharge inception voltage showed that the dielectric breakdown lifetime was 56 hours and the partial discharge inception voltage was 4.40 kV/mm. Table 1 below shows the measurement results.

### Example 4

A film with a thickness of 0.317 mm containing a hexyl-etherified fullerene hydroxide derivative (HexC₆₀) in an amount of 4.136 mmol/kg (0.5% by weight) with respect to the polyamide-imide resin was produced in a way similar to that of Example 1.

Measurement results of the dielectric breakdown lifetime and the partial discharge inception voltage showed that the dielectric breakdown lifetime was 375 hours and the partial discharge inception voltage was 3.51 kV/mm. Table 1 below shows the measurement results.

### Example 5

A hexyl-etherified fullerene derivative (HBC₆₀) without a hydroxyl group was synthesized from fullerene bromide and anhydrous hexanol prepared according to JP-A-2014-172865.

The structural formula of the resulting material was determined as being C₆₀[O(CH₂)₅CH₃]₁₂ from the infrared absorption spectrum (IR spectrum) measurement and the elemental analysis measurement, which means that this material is hexyl-etherified fullerene derivative (HBC₆₀) without a hydroxyl group.

A film with a thickness of 0.357 mm containing a hexyl-etherified fullerene derivative (HBC₆₀) without a hydroxyl group in an amount of 0.518 mmol/kg (0.1% by weight) with respect to the polyamide-imide resin was produced in a way similar to that of Example 1.

Measurement results of the dielectric breakdown lifetime and the partial discharge inception voltage showed that the dielectric breakdown lifetime was 15 hours and the partial discharge inception voltage was 3.82 kV/mm. Table 1 below shows the measurement results.

### Example 6

An octyl-etherified fullerene hydroxide derivative (OctC₆₀) was synthesized from cyclosulfated fullerene (CS) and octanol in a way similar to that of Example 1.

The structural formula of the resulting material was determined as being C₆₀[O(CH₂)₅CH₃]₄(OH)₂ from the infrared absorption spectrum (IR spectrum) measurement and the elemental analysis measurement, which means that this material is octyl-etherified fullerene hydroxide derivative (OctC₆₀).

A film with a thickness of 0.256 mm containing an octyl-etherified fullerene hydroxide derivative (OctC₆₀) in an amount of 0.787 mmol/kg (0.1% by weight) with respect to the polyamide-imide resin was produced in a way similar to that of Example 1.

Measurement results of the dielectric breakdown lifetime and the partial discharge inception voltage showed that the dielectric breakdown lifetime was 60 hours and the partial discharge inception voltage was 3.94 kV/mm. Table 1 below shows the measurement results.

### Example 7

A film with a thickness of 0.317 mm containing a phenyl C₆₁ butyric acid methyl ester (PCBM) in an amount of 1.098 mmol/kg (0.1% by weight) with respect to the polyamide-imide resin was produced in a way similar to that of Example 1.

Measurement results of the dielectric breakdown lifetime and the partial discharge inception voltage showed that the dielectric breakdown lifetime was 17 hours and the partial discharge inception voltage was 3.72 kV/mm. Table 1 below shows the measurement results.

The PCBM (product name: nanom spectra E102) was purchased from Frontier Carbon Corporation.

### Comparative Example 1

In a way similar to that of Example 1, 30.79 g of N-methyl-2-pyrrolidone was added to 30.79 g of polyamide-imide resin (Pyromax HR-11 (concentration: 15% by weight) manufactured by Toyobo Co., Ltd.), and the resulting resin solution was dissolved through ultrasonic treatment. This resin solution was poured into a 120×120×10-mm hollowed-out TEFLON (registered trademark) plate, and defoamed and desolvated at 140° C. using a low-pressure dryer to produce a film with a thickness of 0.295 mm.

Measurement results of the dielectric breakdown lifetime and the partial discharge inception voltage showed that the dielectric breakdown lifetime was 0.88 hours and the partial discharge inception voltage was 3.61 kV/mm. Table 1 below shows the measurement results.

TABLE 1

| | | | | | | Partial |
|---|---|---|---|---|---|---|
| | | | | Dielectric | | discharge |
| | Fullerene derivative | | | breakdown | | inception |
| | | Content | | lifetime | Multiplying | voltage |
| | Composition | wt. %*¹ | mmol/kg | (hrs) | factor*² | (kV/mm) |
| Ex. 1 | Hexyl- | 0.001 | 0.0083 | 20 | 23 | 3.89 |
| Ex. 2 | etherified | 0.01 | 0.083 | 33 | 38 | 3.65 |
| Ex. 3 | fullerene | 0.1 | 0.827 | 56 | 64 | 4.40 |
| Ex. 4 | hydroxide | 0.5 | 4.136 | 375 | 426 | 3.51 |
| Ex. 5 | Hexyl- | 0.1 | 0.518 | 15 | 17 | 3.82 |
| | etherified | | | | | |
| | fullerene | | | | | |
| Ex. 6 | Octyl- | 0.1 | 0.787 | 60 | 68 | 3.94 |
| | etherified | | | | | |
| | fullerene | | | | | |
| | hydroxide | | | | | |
| Ex. 7 | Phenyl C₆₁ | 0.1 | 1.098 | 17 | 19 | 3.72 |
| | butyric acid | | | | | |
| | methyl ester | | | | | |
| Com. | None | 0 | 0 | 0.88 | 1 | 3.61 |
| Ex. 1 | | | | | | |

*¹Fullerene derivative content (wt. %) in resin composition
*²Multiplying factor when dielectric breakdown lifetime of Com. Ex. 1 is taken as “1”

It is seen from the results shown in Table 1 above that all of Examples 1 to 7 had a dielectric breakdown lifetime of 10 hours or longer, that is, had an excellent dielectric breakdown lifetime. Furthermore, when the dielectric breakdown lifetime of Comparative Example 1 constituted only by a resin without a fullerene derivative was taken as “1”, all of Examples 1 to 7 exhibited a high multiplying factor, and it is seen that the dielectric breakdown lifetime is significantly improved compared with that of Comparative Example 1.

Furthermore, it is seen from Examples 1 to 3 and 5 to 7 that it is possible to obtain an excellent dielectric breakdown lifetime and increase the partial discharge inception voltage even when the amount of fullerene derivative added is small (0.1% by weight or less).

### Example 8

### Production of Epoxy Resin Composition and Epoxy Resin Composition Sheet

First, 25.2 mg of hexyl-etherified fullerene hydroxide derivative (HexCᵤ) was added to 28 g of N-methyl-2-pyrrolidone (SP value: 11.2) and subjected to ultrasonic treatment to prepare a solution. This solution was added to 28.01 g of epoxy resin base (jER828 manufactured by Mitsubishi Chemical Holdings Corporation), and the resulting resin solution was subjected to ultrasonic treatment and defoamed and desolvated at 160° C. using a low-pressure dryer to produce a composite of the hexyl-etherified fullerene derivative and the epoxy resin base. Then, 22.41 g of curing agent (HN-2200 manufactured by Hitachi Chemical Company, Ltd.) and 0.28 g of 1-(2-cyanoethyl)-2-ethyl-4-methylimidazole (manufactured by Tokyo Chemical Industry Co., Ltd.) serving as a curing accelerator were added to this composite, and the resulting resin solution was subjected to ultrasonic treatment and defoamed at 50° C. to obtain a resin composition.

The content of hexyl-etherified fullerene derivative was 0.05% by weight of the resin composition (solid content), and the content of hexyl-etherified fullerene derivative in a cured product after heat curing, which will be described next, was also 0.05% by weight.

This resin composition was poured into a Teflon plate, and heat cured at 70° C. for 15 hours to produce an epoxy resin sheet (cured product) with an average thickness of 1.348 mm.

### Dielectric Breakdown Lifetime of Sheet

A sheet sample cut to have a size of 50 mm×50 mm was subjected to the breakdown voltage measurement using an AC high voltage generator (“100 kV 20 kVA” manufactured by Tokyo Henatsuki K. K.) under the conditions of electrode: in electrically insulating oil, voltage rise rate: 1 kV/sec, current: AC, and frequency: 60 Hz.

The dielectric breakdown lifetime was obtained from the above-mentioned breakdown voltage measurement results following the procedure described in (1) to (4) of “Dielectric Breakdown Lifetime of Film” of Example 1, except that the threshold was set to 15 kV/mm.

### Partial Discharge Inception Voltage of Sheet

The partial discharge inception voltage was measured under the same conditions as those described in “Partial Discharge Inception Voltage of Film” of Example 1, except that the voltage rise rate was set to 0.05 kV/sec.

These measurement results showed that the dielectric breakdown lifetime in the withstand voltage measurement was 4.08×10⁴ hours and the partial discharge inception voltage was 1.96 kV/mm. Table 2 below shows the measurement results.

### Example 9

An epoxy resin sheet with an average thickness of 1.312 mm containing 50.4 mg of hexyl-etherified fullerene hydroxide (HexC₆₀) (a content of 0.1% by weight of the resin composition) was produced in a way similar to that of Example 8.

Measurement results of the dielectric breakdown lifetime and the partial discharge inception voltage showed that the dielectric breakdown lifetime in the withstand voltage measurement was 7.39×10⁶ hours and the partial discharge inception voltage was 2.11 kV/mm. Table 2 below shows the measurement results.

### Comparative Example 2

An epoxy resin sheet with an average thickness of 1.318 mm was produced in a way similar to that of Example 8, except that hexyl-etherified fullerene hydroxide (HexC₆₀) was not used.

Measurement results of the dielectric breakdown lifetime and the partial discharge inception voltage showed that the dielectric breakdown lifetime in the withstand voltage measurement was 4.86 hours and the partial discharge inception voltage was 1.93 kV/mm. Table 2 below shows the measurement results.

TABLE 2

| | | | | | | Partial |
|---|---|---|---|---|---|---|
| | | | | Dielectric | | discharge |
| | Fullerene derivative | | | breakdown | | inception |
| | | Content | | lifetime | Multiplying | voltage |
| | Composition | wt. %*¹ | mmol/kg | (hrs) | factor*² | (kV/mm) |
| Ex. 8 | Hexyl- | 0.05 | 0.414 | 4.08 × 10⁴ | 8.40 × 10³ | 1.96 |
| Ex. 9 | etherified | 0.1 | 0.827 | 7.39 × 10⁶ | 1.52 × 10⁶ | 2.11 |
| | fullerene | | | | | |
| | hydroxide | | | | | |
| Com. | None | 0 | 0 | 4.86 | 1 | 1.93 |
| Ex. 2 | | | | | | |

*¹Fullerene derivative content (wt. %) in resin composition
*²Multiplying factor when dielectric breakdown lifetime of Com. Ex. 2 is taken as “1”

It is seen from the results shown in Table 2 above that the epoxy resin sheets of Examples 8 and 9 both had a very long dielectric breakdown lifetime, that is, had an excellent dielectric breakdown lifetime. Furthermore, when the dielectric breakdown lifetime of Comparative Example 2 constituted only by a resin without a fullerene derivative was taken as “1”, all of Examples 1 to 7 exhibited a very high multiplying factor, and it is seen that the dielectric breakdown lifetime is significantly improved compared with that of Comparative Example 2.

### Example 10

### Production of Enamel Wire Coating Solution

First, 4.64 mg of hexyl-etherified fullerene hydroxide (HexC₆₀) (a content of 0.05% by weight of the resin composition) in the same lot as Example 1 was added to 10 g of N-methyl-2-pyrrolidone, and subjected to ultrasonic treatment to prepare an additive solution. This solution was added to 61.55 g of polyamide-imide resin (Pyromax HR-11 (concentration: 15% by weight) manufactured by Toyobo Co., Ltd.), and the resulting resin solution was subjected to ultrasonic treatment to prepare a coating solution.

### Production of Enamel Wire

A surface-untreated copper wire (#20, diameter 0.9 mm, manufactured by Daidohant Co., Ltd.) was immersed in the coating solution and then placed through a die (hole diameter: 1.2 mm). Subsequently, the wire was dried using a dryer at 230° C. to produce an enamel wire having a uniform coating with a thickness of about 30 to 40 μm.

### Dielectric Breakdown Lifetime of Enamel Wire

The withstand voltage (dielectric breakdown lifetime) of a twisted pair enamel wire twisted 8 times as defined in JIS C3216-5 was measured using a withstand voltage and insulation resistance tester (Kikusui Electronics Corporation, TOS5302 (frequency 60 Hz)).

The dielectric breakdown lifetime was obtained from the above-mentioned breakdown voltage measurement results following the procedure described in (1) to (4) of “Dielectric Breakdown Lifetime of Film” of Example 1, except that the threshold was set to 50 kV/mm.

Measurement results of the dielectric breakdown lifetime showed that the dielectric breakdown lifetime in the withstand voltage measurement was 66 hours. Table 3 below shows the measurement results.

### Example 11

In a way similar to that of Example 10, 9.28 mg of hexyl-etherified fullerene hydroxide (HexC₆) (a content of 0.1% by weight of the resin composition) was added to 10 g of N-methyl-2-pyrrolidone, and subjected to ultrasonic treatment to prepare an additive solution. This solution was added to 61.55 g of polyamide-imide resin (Pyromax ER-11 (concentration: 15% by weight) manufactured by Toyobo Co., Ltd.), and the resulting resin solution was subjected to ultrasonic treatment to prepare a coating solution. This coating solution was used to produce an enamel wire having a uniform coating with a thickness of about 30 to 40 μm.

Measurement results of the dielectric breakdown lifetime and the partial discharge inception voltage showed that the dielectric breakdown lifetime in the withstand voltage measurement was 102 hours and the partial discharge inception voltage was 0.54 kV.

The partial discharge inception voltage was measured under the same conditions as those described in “Partial Discharge Inception Voltage of Sheet” of Example 8.

### Example 12

In a way similar to that of Example 10, 46.4 mg of hexyl-etherified fullerene hydroxide (HexC₆₀) (a content of 0.5% by weight of the resin composition) was added to 10 g of N-methyl-2-pyrrolidone, and subjected to ultrasonic treatment to prepare an additive solution. This solution was added to 61.55 g of polyamide-imide resin (Pyromax HR-11 (concentration: 15% by weight) manufactured by Toyobo Co., Ltd.), and the resulting resin solution was subjected to ultrasonic treatment to prepare a coating solution. This coating solution was used to produce an enamel wire having a uniform coating with a thickness of about 30 to 40 μm.

Measurement results of the dielectric breakdown lifetime showed that the dielectric breakdown lifetime in the withstand voltage measurement was 444 hours. Table 3 below shows the measurement results.

### Example 13

In a way similar to that of Example 10, 9.28 mg of octyl-etherified fullerene hydroxide (OctC₆₀) (a content of 0.1% by weight of the resin composition) was added to 10 g of N-methyl-2-pyrrolidone, and subjected to ultrasonic treatment to prepare an additive solution. This solution was added to 61.55 g of polyamide-imide resin (Pyromax HR-11 (concentration: 15% by weight) manufactured by Toyobo Co., Ltd.), and the resulting resin solution was subjected to ultrasonic treatment to prepare a coating solution. This coating solution was used to produce an enamel wire having a uniform coating with a thickness of about 30 to 40 μm.

Measurement results of the dielectric breakdown lifetime showed that the dielectric breakdown lifetime in the withstand voltage measurement was 3389 hours. Table 3 below shows the measurement results.

### Example 14

In a way similar to that of Example 10, 9.28 mg of phenyl C₆1 butyric acid methyl-esterified fullerene derivative (DCBM) (a content of 0.1% by weight of the resin composition) was added to 10 g of N-methyl-2-pyrrolidone, and subjected to ultrasonic treatment to prepare an additive solution. This solution was added to 61.55 g of polyamide-imide resin (Pyromax HR-11 (concentration: 15% by weight) manufactured by Toyobo Co., Ltd.), and the resulting resin solution was subjected to ultrasonic treatment to prepare a coating solution. This coating solution was used to produce an enamel wire having a uniform coating with a thickness of about 30 to 40 μm.

Measurement results of the dielectric breakdown lifetime showed that the dielectric breakdown lifetime in the withstand voltage measurement was 1.41 hours. Table 3 below shows the measurement results.

### Comparative Example 3

An enamel wire having a uniform coating with a thickness of about 30 to 40 μm was produced in in a way similar to that of Example 10, except that hexyl-etherified fullerene hydroxide (HexC₆₀) was not used.

Measurement results of the dielectric breakdown lifetime and the partial discharge inception voltage showed that the dielectric breakdown lifetime in the withstand voltage measurement was 0.48 hours and the partial discharge inception voltage was 0.45 kV. Table 3 below shows the measurement results.

TABLE 3

| | | | | | | Partial |
|---|---|---|---|---|---|---|
| | | | | Dielectric | | discharge |
| | Fullerene derivative | | | breakdown | | inception |
| | | Content | | lifetime | Multiplying | voltage |
| | Composition | wt. %*¹ | mmol/kg | (hrs) | factor*² | (kV) |
| Ex. 10 | Hexyl- | 0.05 | 0.414 | 66 | 138 | — |
| Ex. 11 | etherified | 0.1 | 0.827 | 102 | 214 | 0.54 |
| Ex. 12 | fullerene | 0.5 | 4.136 | 444 | 936 | — |
| | hydroxide | | | | | |
| Ex. 13 | Octyl- | 0.1 | 0.787 | 3389 | 7135 | — |
| | etherified | | | | | |
| | fullerene | | | | | |
| | hydroxide | | | | | |
| Ex. 14 | Phenyl C₆₁ | 0.1 | 1.098 | 1.41 | 3 | — |
| | butyric acid | | | | | |
| | methyl ester | | | | | |
| Com. | None | 0 | 0 | 0.48 | 1 | 0.45 |
| Ex. 3 | | | | | | |

*¹Fullerene derivative content (wt. %) in resin composition
*²Multiplying factor when dielectric breakdown lifetime of Com. Ex. 3 is taken as “1”

It is seen from the results shown in Table 3 above that all enamel wires of Examples 10 to 13 had a dielectric breakdown lifetime of 50 hours or longer, that is, had an excellent dielectric breakdown lifetime. Furthermore, when the dielectric breakdown lifetime of the enamel wire (Comparative Example 3) constituted by a resin composition without a fullerene derivative was taken as “1”, all of Example 10 to 14 exhibited a high multiplying factor, and it is seen that the dielectric breakdown lifetime of the enamel wires is significantly improved compared with that of Comparative Example 3.

Furthermore, it is seen from Example 11 that it is possible to increase the partial discharge inception voltage compared with Comparative Example 3 without a fullerene derivative, even when the amount of fullerene derivative added to the enamel wire is small (0.1% by weight).

Specific aspects of the present disclosure were described in the above-described examples, but the above-described examples are merely examples and should not be construed as limiting the present disclosure. Various alterations that are obvious to those skilled in the art are intended to be within the scope of the present disclosure.

The resin composition, the resin paint, the resin coating, and the enamel wire obtained by the production method of the present disclosure can suppress a decrease in the life of an insulation against surge voltage, and thus they can be advantageously used in any of the following applications including materials for automobiles, materials for electrical and electronic equipment, and materials for industrial machinery.

1. A method for producing a fullerene-derivative-containing resin composition containing a fullerene derivative and a resin that has an affinity for a polar solvent, comprising:
a step (I) of dispersing a fullerene derivative in a polar solvent; and
a step (II) of mixing the polar solvent in which the fullerene derivative is dispersed with a resin that has an affinity for the polar solvent.

2. The method for producing a fullerene-derivative-containing resin composition according to claim 1, wherein the fullerene derivative is a fullerene expressed by General Formula (1) below:
Cₙ[O(CH₂)ₓCH₃]_{y}(OH)_{z} (1)
where n is an integer of 60 or more, x is an integer of 3 or more, y is an integer of 1 or more, and z is an integer of 0 or more.

3. The method for producing a fullerene-derivative-containing resin composition according to claim 1, wherein the polar solvent is a solvent having an amide bond.

4. The method for producing a fullerene-derivative-containing resin composition according to claim 1, wherein the polar solvent is N-methyl-2-pyrrolidone.

5. A fullerene-derivative-containing resin composition obtained by the method for producing a fullerene-derivative-containing resin composition according to claim 1.

6. A fullerene-derivative-containing resin composition comprising: a fullerene derivative; and a resin that has an affinity for a polar solvent, wherein the resin composition has a dielectric breakdown lifetime that is 10 or more times as long as a dielectric breakdown lifetime of a resin without the fullerene derivative, as measured according to measurement conditions below:
the resin composition shaped to have a size of 50×50×0.2 to 0.4 mm is used as a test piece and measured in an AC voltage range of 10 to 100 kV and at a voltage rise rate of 1 kV/sec and a frequency of 60 Hz.

7. The fullerene-derivative-containing resin composition according to claim 6, wherein the fullerene derivative is contained in an amount of 0.0001 to 5% by weight of the resin composition.

8. A resin paint comprising, as a main component, the fullerene-derivative-containing resin composition according to claim 6.

9. A resin coating obtained by solidifying the resin paint according to claim 8.

10. An enamel wire comprising: a conductor; and the resin coating according to claim 9 arranged on an outer circumferential face of the conductor.
